(19) United States
(12) Patent Application Publication
(10) Pub. No.: US 2024/0283807 A1
(43) Pub. Date: Aug. 22, 2024

(54) METHOD AND SYSTEM FOR HIERARCHICAL DEVICE GROUPING AND CONTEXT BASED FEATURE ENGINEERING

(71) Applicant: Aeris Communications, Inc., San Jose, CA (US)

(72) Inventors: Jins George, Fremont, CA (US); Hyungho Kim, Cupertino, CA (US); Subramanian Balakrishnan, Cupertino, CA (US); Sundararaj Arunachalam, Naperville, IL (US)

(21) Appl. No.: 18/583,034

(22) Filed: Feb. 21, 2024

Related U.S. Application Data
(60) Provisional application No. 63/486,198, filed on Feb. 21, 2023.

(51) Int. Cl. H04L 9/40

(52) U.S. Cl. CPC H04L 63/1425

(57) ABSTRACT

In one or more embodiments, computer-implemented systems, methods and computer-program products for hierarchical grouping of devices, detecting network intrusions and/or user misuse in a SaaS platform by using grouping of devices, and detecting network intrusions and/or user misuse in a Software as a Service (SaaS) platform by applying feature engineering technique to derived device groups are disclosed.

### CROSS-REFERENCE TO RELATED APPLICATIONS

Under 35 USC 119(e), this application claims priority to U.S. provisional application Ser. No. 63/486,198, entitled “METHOD AND SYSTEM FOR HIERARCHICAL DEVICE GROUPING AND CONTEXT BASED FEATURE ENGINEERING”, filed on Feb. 21, 2023, all of which is herein incorporated by reference in its entirety.

### FIELD OF THE INVENTION

The present invention relates generally to hierarchical grouping of devices and context-based feature engineering in a Software as a Service (SaaS) platform.

### BACKGROUND

The anomaly-based detection is a very powerful machine learning method for detecting network intrusions and/or user misuse, but it often suffers from high false-positive rates and the results can be even more severe in multi-tenant SaaS environments as network patterns can be highly reliant on tenants' service patterns.

Accordingly, what are needed are system and method to address the above identified issues. The present invention addresses such a need.

### SUMMARY

Computer-implemented systems, methods and computer-program products for hierarchical grouping of devices, detecting network intrusions and/or user misuse in a SaaS platform by using grouping of devices, and detecting network intrusions and/or user misuse in a Software as a Service (SaaS) platform by applying feature engineering technique to derived device groups are disclosed. The computer-implemented method for hierarchical grouping of devices includes receiving device information for the one or more devices; receiving metadata related to network traffic flow for the one or more devices; grouping the devices based on any one or more of: received device data, received network traffic flow metadata, or a combination thereof; dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

The system for hierarchical grouping of devices including a processor and a database, wherein the system is configured to: receive device information for the one or more devices; receive metadata related to network traffic flow for the one or more devices; group the devices based on any one or more of: received device data, received network traffic flow metadata, or a combination thereof; dynamically group the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

In an embodiment, a computer program product for hierarchical grouping of devices is also disclosed. The computer program product stored on a non-transitory computer readable medium for hierarchical grouping of devices, comprising computer readable instructions for causing a computer to control an execution of an application for hierarchical grouping of devices in a SaaS platform comprising: receiving device information for the one or more devices; receiving metadata related to network traffic flow for the one or more devices; grouping the devices based on any one or more of: received device data, received network traffic flow metadata, or a combination thereof; dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

In one or more embodiments, the method, system and computer program product further include using grouping of devices for detecting network intrusions and/or user misuse in a SaaS platform, wherein using grouping of devices for detecting network intrusions and/or user misuse in a SaaS platform includes detecting device level network traffic anomaly in a IoT SaaS connectivity platform.

In one or more embodiments, the method, system and computer program product for detecting network intrusions and/or user misuse in a SaaS platform using grouping of devices further includes applying feature engineering technique to each group including any of: extracting features, selecting features, transforming features, and combining features, or a combination thereof, based on the group.

In one or more embodiments, the method, system and computer program product for detecting network intrusions and/or user misuse in a SaaS platform using grouping of devices and applying feature engineering technique further includes detecting device level network traffic anomaly with any of the said groups in a IoT SaaS connectivity platform.

### BRIEF DESCRIPTION OF THE DRAWINGS

FIG. 1A illustrates an exemplary process 100 used for hierarchical grouping of devices in accordance with one or more embodiments of the present invention.

FIG. 1B illustrates an exemplary process 100′ used for using hierarchical grouping of devices for detecting network intrusions and/or user misuse in a SaaS platform in accordance with one or more embodiments of the present invention.

FIG. 1C an exemplary process 100″ used for applying feature engineering technique or process to derived device groups for detecting network intrusions and/or user misuse in a Software as a Service (SaaS) platform in accordance with one or more embodiments of the present invention.

FIG. 2 illustrates an exemplary system 200 used for carrying out processes 100, 100′ and 100″ used for hierarchical grouping of devices, and using hierarchical grouping of devices for detecting network intrusions and/or user misuse in a SaaS platform respectively in accordance with one or more embodiments of the present invention.

FIGS. 3A, 3B and 3C illustrate exemplary systems and processes 300, 300′ and 300″ for applying feature engineering techniques/processes to derived device groups for detecting network intrusions and/or user misuse in a SaaS platform in accordance with one or more embodiments of the present invention.

FIG. 4 illustrates a data processing system 400 suitable for storing the computer program product and/or executing program code relating to the hierarchical grouping of devices, using hierarchical grouping of devices for detecting network intrusions and/or user misuse in a SaaS platform and applying feature engineering technique(s)/process(es) to derived device groups for detecting network intrusions and/or user misuse in a SaaS platform in accordance with one or more embodiments of the present invention.

### DETAILED DESCRIPTION

The present invention relates generally to hierarchical grouping of devices and context-based feature engineering in a Software as a Service (SaaS) platform.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Although the invention is described with respect to device as used herein the term “device” is intended to be inclusive, interchangeable, and/or synonymous with IoT devices including appliances, electronic modules, telephony equipment and other similar devices that have distinct identifying numbers, such as IMEIs, ICCIDs, IMSIs, MEIDs or other serial numbers as described further below and collectively referred to herein as “device identifier”, for that device, though one will recognize that functionally different types of devices may have characteristics, functions and/or operations which may be specific to their individual capabilities and/or deployment.

The anomaly-based detection is a very powerful machine learning method for detecting network intrusions and/or user misuse, but it often suffers from high false-positive rates and the results can be even more severe in multi-tenant SaaS environments as network patterns can be highly reliant on tenants' service patterns.

To overcome the issues described above with existing anomaly-based detection of network intrusions and/or user misuse in a SaaS platform, a separate preprocessing step of building groups at the account level (or extended hierarchical multi-level, e.g. platform-level, account-level, subgroup-level (for example, tenant-based grouping, device profile-based grouping, device communication behavior based grouping, etc.), etc.) is utilized.

In an embodiment, the method, system and computer program product further includes using the hierarchical grouping of devices for detecting network intrusions and/or user misuse in a SaaS platform, wherein using grouping of devices for detecting network intrusions and/or user misuse in a SaaS platform includes detecting device level network traffic anomaly in a IoT SaaS connectivity platform.

Additionally, in one or more embodiments, feature engineering is conducted based on the groups. Automatic grouping using machine learning makes it easy for a user/administrator to segment the devices and configure anomaly detection at specific groups.

It is almost impossible for human to group millions of devices based on multiple features periodically and apply anomaly detection. By using Machine learning algorithms, computer system can automatically group the devices and build anomaly detection models per group.

Additionally, or alternatively, user defined grouping or predefined grouping or regrouping based on data and/or experience may also be provided. For example, for customers with limited number of devices, manual grouping may be performed, wherein the algorithm may provide suggestions for such grouping.

To describe the features of the present invention in more detail within the context of IoT devices, for example, sensors, gadgets, appliances, connected vehicles and others that communicate over the internet for the purpose of connecting and exchanging data with other devices and systems, refer to the accompanying figures in conjunction with the following discussions. These examples are used for purpose of illustration only, and should not be construed as limitations.

The embodiments described herein disclose computer-implemented systems, methods and computer-program products for hierarchical grouping of devices, detecting network intrusions and/or user misuse in a SaaS platform by using grouping of devices, and detecting network intrusions and/or user misuse in a Software as a Service (SaaS) platform by applying feature engineering techniques/processes to derived device groups.

The computer-implemented method for hierarchical grouping of devices includes receiving device information for the one or more devices; receiving metadata related to network traffic flow for the one or more devices; grouping the devices based on any one or more of: received device data, received network traffic flow metadata, or a combination thereof; dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

The system for hierarchical grouping of devices including a processor and a database, wherein the system is configured to: receive device information for the one or more devices; receive metadata related to network traffic flow for the one or more devices; group the devices based on any one or more of: received device data, received network traffic flow metadata, or a combination thereof; dynamically group the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

The computer program product stored on a non-transitory computer readable medium for hierarchical grouping of devices, comprising computer readable instructions for causing a computer to control an execution of an application for hierarchical grouping of devices in a SaaS platform comprising: receiving device information for the one or more devices; receiving metadata related to network traffic flow for the one or more devices; grouping the devices based on any one or more of: received device data, received network traffic flow metadata, or a combination thereof; dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

The parameters or features derived from any one or more of the said parameters or attributes may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count for profile (protocol_count for profile), etc. A person skilled in the art may readily understand that although some derived parameters/features are listed here, they are provided as example only, and many different and/or additional parameters/features may be used that is within the spirit and scope of this invention.

In one or more embodiments, the method, system and computer program product further include using grouping of devices for detecting network intrusions and/or user misuse in a SaaS platform, wherein using grouping of devices for detecting network intrusions and/or user misuse in a SaaS platform includes detecting device level network traffic anomaly in a IoT SaaS connectivity platform.

In one or more embodiments, the method, system and computer program product for detecting network intrusions and/or user misuse in a SaaS platform using grouping of devices further includes applying feature engineering techniques/processes to each group including any of: extracting features, selecting features, transforming features, and combining features, or a combination thereof, based on the group.

In one or more embodiments, the method, system and computer program product for detecting network intrusions and/or user misuse in a SaaS platform using grouping of devices and applying feature engineering techniques/processes further includes detecting device level network traffic anomaly with any of the said groups in a IoT SaaS connectivity platform.

Feature engineering technique as used herein may be defined as extracting and/or selecting raw data attributes, and manipulating and/or transforming the selected raw data attributes into variables or features that can be used in supervised and/or unsupervised learning.

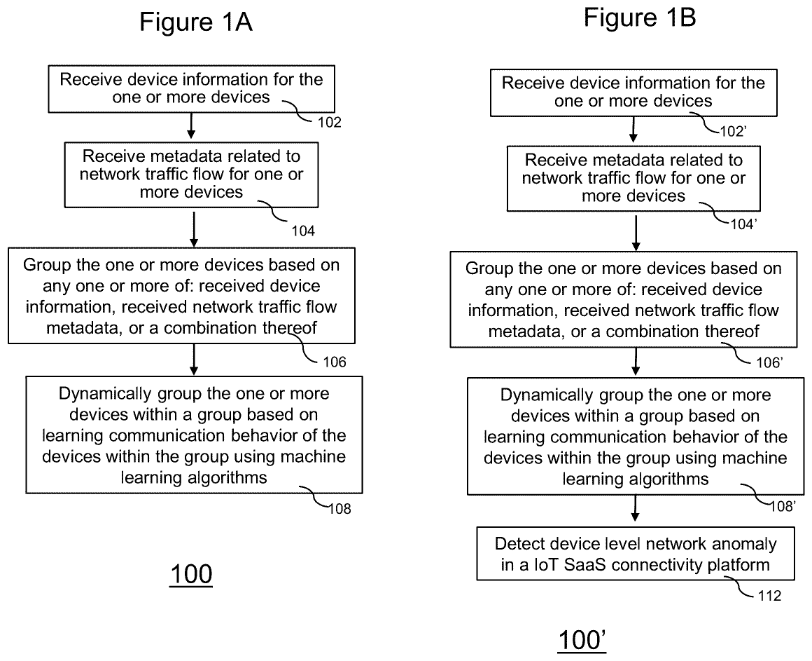

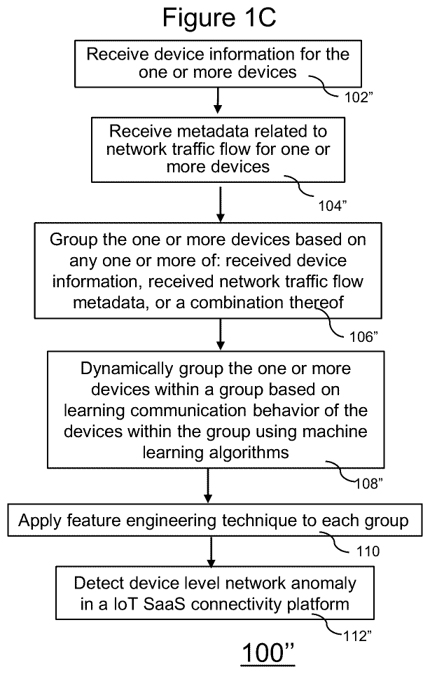

FIG. 1A illustrates an exemplary process 100 used for hierarchical grouping of devices in accordance with one or more embodiments of the present invention.

As illustrated in FIG. 1A, the computer-implemented method for hierarchical grouping of devices includes receiving device information for the one or more devices via step 102; receiving metadata related to network traffic flow for the one or more devices via step 104; grouping the devices based on any one or more of: received device data, received network traffic flow metadata, or a combination thereof via step 106; and dynamically grouping the one or more devices within the said group, via step 108, based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

The parameters or features derived from any one or more of the said parameters or attributes may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count per profile (protocol_count for profile), etc. A person skilled in the art may readily understand that although some derived parameters/features are listed here, they are provided as example only, and many different and/or additional parameters/features may be used that is within the spirit and scope of this invention.

FIG. 1B illustrates an exemplary process 100′ for detecting network intrusions and/or user misuse in a SaaS platform using hierarchical grouping of devices in accordance with one or more embodiments of the present invention. As illustrated in FIG. 1B, the computer-implemented method for detecting network intrusions and/or user misuse in a SaaS platform using hierarchical grouping of devices includes receiving device information for the one or more devices via step 102′; receiving metadata related to network traffic flow for the one or more devices via step 104′; grouping the devices based on any one or more of: received device data, received network traffic flow metadata, or a combination thereof via step 106′; dynamically grouping the one or more devices within the said group, via step 108′, based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters; and detecting device level network anomaly in a IoT SaaS connectivity platform via step 112.

The parameters or features derived from any one or more of the said parameters or attributes may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count per profile (protocol_count for profile), etc. A person skilled in the art may readily understand that although some derived parameters/features are listed here, they are provided as example only, and many different and/or additional parameters/features may be used that is within the spirit and scope of this invention.

FIG. 1C illustrates an exemplary process 100″ for detecting network intrusions and/or user misuse in a SaaS platform using application of feature engineering to the derived device groups in accordance with one or more embodiments of the present invention. As illustrated in FIG. 1C, in an embodiment, the computer-implemented method for detecting network intrusions and/or user misuse in a SaaS platform further includes applying feature engineering technique/process to each of the derived device group(s) including any of: extracting features, selecting features, transforming features, and combining features, or a combination thereof, based on the group via step 110; and detecting device level network anomaly in a IoT SaaS connectivity platform via step 112″.

For example, the method for detecting network intrusions and/or user misuse in a SaaS platform includes receiving device information for the one or more devices via step 102″; receiving metadata related to network traffic flow for the one or more devices via step 104″; grouping the devices based on any one or more of: received device data, received network traffic flow metadata, or a combination thereof via step 106″; dynamically grouping the one or more devices within the said group, via step 108″, based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters; applying feature engineering technique/process to each of the derived device group(s) including any of: extracting features, selecting features, transforming features, and combining features, or a combination thereof, based on the group via step 110; and detecting device level network anomaly in a IoT SaaS connectivity platform via step 112″.

The parameters or features derived from any one or more of the said parameters or attributes may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count per profile (protocol_count for profile), etc. A person skilled in the art may readily understand that although some derived parameters/features are listed here, they are provided as example only, and many different and/or additional parameters/features may be used that is within the spirit and scope of this invention.

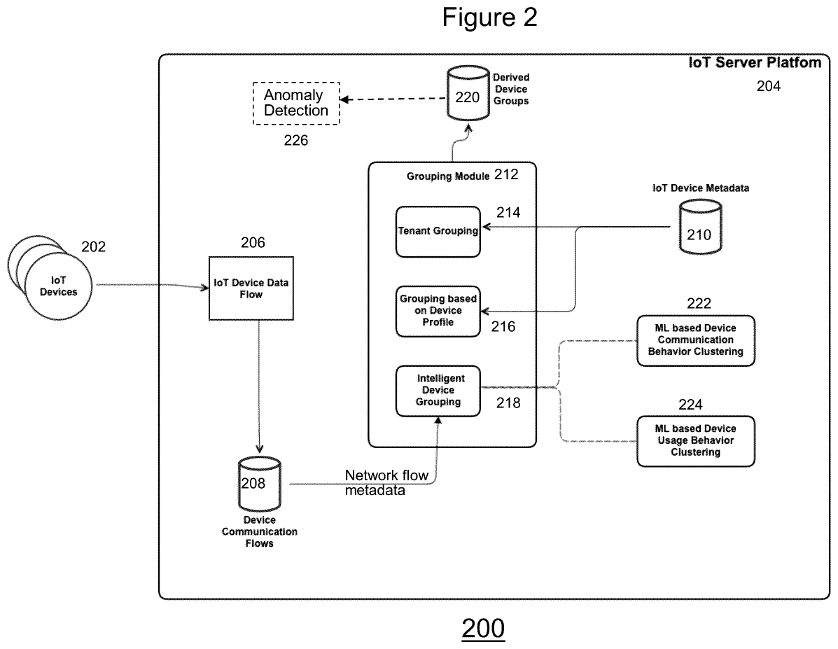

FIG. 2 illustrates an exemplary system and process 200 for the system for hierarchical grouping of devices comprises an IoT server platform 204 including a processor and memory, wherein the IoT platform 204 is configured to receive metadata related to network traffic flow as IoT device data flow 206 for one or more devices 202 and saves the received device communication flows in a database 208.

The device profile-based grouping 220 may also be configured to use device hardware information (e.g., device hardware type, model, etc.) that may be derived from the device hardware id such as IMEI/MEID/ESN, for example, IoT device metadata 210. The IoT device may include information related to the IoT device such as but not limited to: device identifier, account information, tenant identifier, device profile, etc. A grouping module 212 in the IoT platform 204 automatically learns the groups within an account using parameters such as but not limited to destination IP, destination port, protocol, data usage, time of the day, day of the week, device model, ratio of mobile originated (MO) traffic to mobile terminated (MT) traffic, and parameters derived from any one or more of the said parameters, and dynamically groups the one or more devices 202 within an account based on any one or more of: destination IP, destination port, protocol, data usage, time of the day, day of the week, device model, ratio of mobile originated (MO) traffic to mobile terminated (MT) traffic, and parameters derived from any one or more of the said parameters.

The parameters or features derived from any one or more of the said parameters or attributes may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count per profile (protocol_count for profile), etc. A person skilled in the art may readily understand that although some derived parameters/features are listed here, they are provided as example only, and many different and/or additional parameters/features may be used that is within the spirit and scope of this invention.

The IoT platform 204 learns communication behavior of the devices from device communication flows 208 as network flow metadata for each device. The IoT platform 204 learns communication behavior of the devices belonging to one or more groups within the account using machine learning algorithms such as clustering. Examples of such groupings may include tenant-based grouping, profile-based grouping, intelligent device grouping, etc. The device groups 220 derived by the grouping module 212 may be used for further processing, for example, anomaly detection 226 which is utilized for detecting network intrusions and/or user misuse in a SaaS platform. For example, automatic learning of network traffic flow metadata fingerprint for a group of devices may be used to identify anomalies, for example by using ML based anomaly threshold finder and thereby detecting device level network traffic anomaly with any of the said groups in a IoT SaaS connectivity platform.

For tenant-based grouping 214, the devices may be grouped based on IoT device metadata 210, for example, device identifier, tenant id, etc., which can be characterized as static grouping. For example, an organization may have multiple accounts within a connectivity platform and the devices may be grouped based on the account also referred to herein as tenant. For example, if organization A has 3 Tenants and 100,000 devices spread across all Tenants: Tenant 1, Tenant 2 & Tenant 3. The grouping module may group the devices into group 1 (30,000 devices), group 2 (30,000 devices) and group 3 (40,000 devices) based on the tenant ID associated with each device.

For device profile-based grouping 216, the grouping module 212 may group devices based on IoT device metadata 210, for example, device identifier, profile the device is assigned to, etc. For example, for a tenant with 50,000 devices and 3 different profiles, profile 1 (with rate plan 1), profile 2 (with rate plan 2) and profile 3 (with rate plan 3) the devices may be grouped into group 1 (10,000 devices), group 2 (25,000 devices) and group 3 (15,000 devices).

For intelligent device grouping 218, the grouping module 212 automatically learns the groups based on network flow metadata within an account from device communication flows 208 using parameters, also referred to herein as features, like device identifier, destination IP, destination port, protocol, data usage, and optionally derived features like time of the day, day of the week, ratio of mobile originated (MO) traffic to mobile terminated (MT) traffic, along with device model to group/cluster the devices, and any parameters or features derived from these base parameters. For example, in intelligent device grouping 218, the system may learn communication behavior of the devices within an account as illustrated by 222, for example, based on any one or more features described above (like device identifier, destination IP, destination port, protocol, data usage, and optionally derived features like time of the day, day of the week, ratio of mobile originated (MO) traffic to mobile terminated (MT) traffic, along with device model to group/cluster the devices, and any parameters or features derived from these base parameters, etc.), or usage behavior of the devices within an account as illustrated by 224, for example, based on any one or more features described above (like device identifier, destination IP, destination port, protocol, data usage, and optionally derived features like time of the day, day of the week, ratio of mobile originated (MO) traffic to mobile terminated (MT) traffic, along with device model, and any parameters or features derived from these base parameters, etc.), from device communication flows 208 using machine learning like clustering.

The parameters or features derived from any one or more of the said parameters or attributes used at 222 and/or 224 may include but are not limited to ratio of mobile originated (MO) packets (traffic) to mobile terminated (MT) packets (traffic) (packets_mo_mt_ratio), average MO packets per minute (avg_mo_packet_per_minute), destination port entropy (dest_port_entropy), average MO bytes per minute (avg_mo_bytes_per_min), average MT bytes per minute (avg_mt_bytes_per_min) and protocol count per profile (protocol_count for profile), etc. A person skilled in the art may readily understand that although some derived parameters/features are listed here, they are provided as example only, and many different and/or additional parameters/features may be used that is within the spirit and scope of this invention.

The intelligent device grouping may be applied at account level, or to each of the groups derived based on tenant ID, device profile, etc. Although, account-based grouping, tenant-based grouping and profile-based grouping are described herein, other types of groupings and other hierarchical levels for grouping may also be used and are within the spirit and scope of this invention.

For example, assume tenant A has 50,000 devices. A machine learning algorithm like clustering may be used with parameters or features, also referred to herein as attributes, for example, destination IP, destination port, protocol, data usage, and optionally derived features, for example, time of the day for data transfer, day of the week for data transfer, device make/model, etc.

The output of the clustering may result in creating a number of groups, for example, 15,000 devices belonging to device model ‘Model 1’ transmit X kilobytes of data to http://example.com at 7 AM every day; 10,000 devices belonging to device model ‘Model 2’ transmit Y kilobytes of data to ABC home page abc.xyc.com at 1 AM every Monday; and 25,000 devices belonging to device model ‘Model 3’ transmit Z kilobytes of data to ABC home page abc.xyc.com every 15 minutes. When an anomaly detection algorithm is applied at each of this group level, the detected anomalies have a high confidence level (or low false positive rate) as devices within the group have similar communication pattern.

Additionally, or alternatively, user defined grouping or predefined grouping or regrouping based on data and/or experience may also be provided. For example, for customers with limited number of devices, manual grouping may be performed, wherein the algorithm may provide suggestions for such grouping.

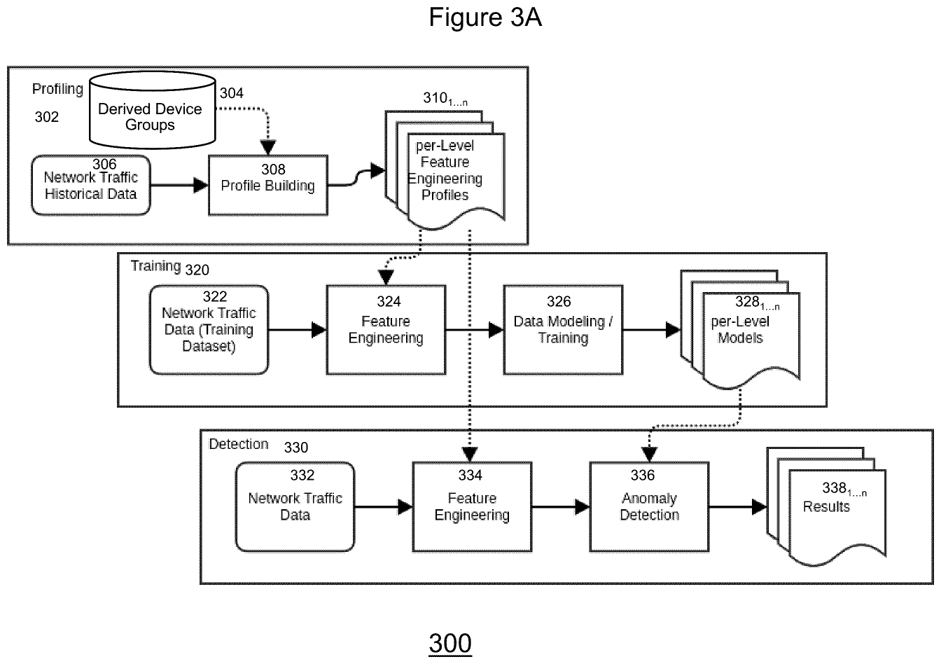

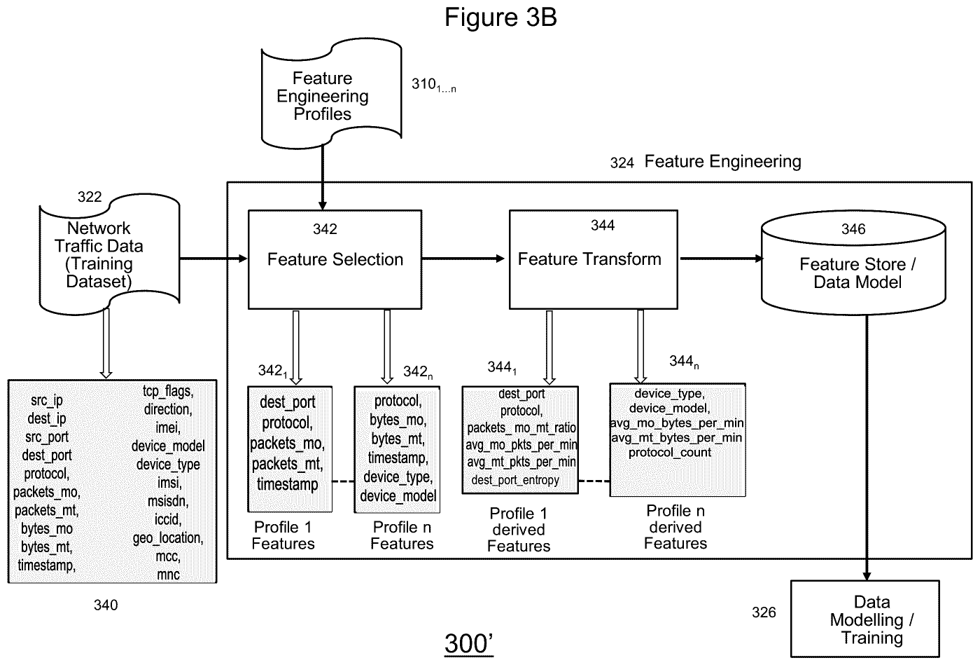

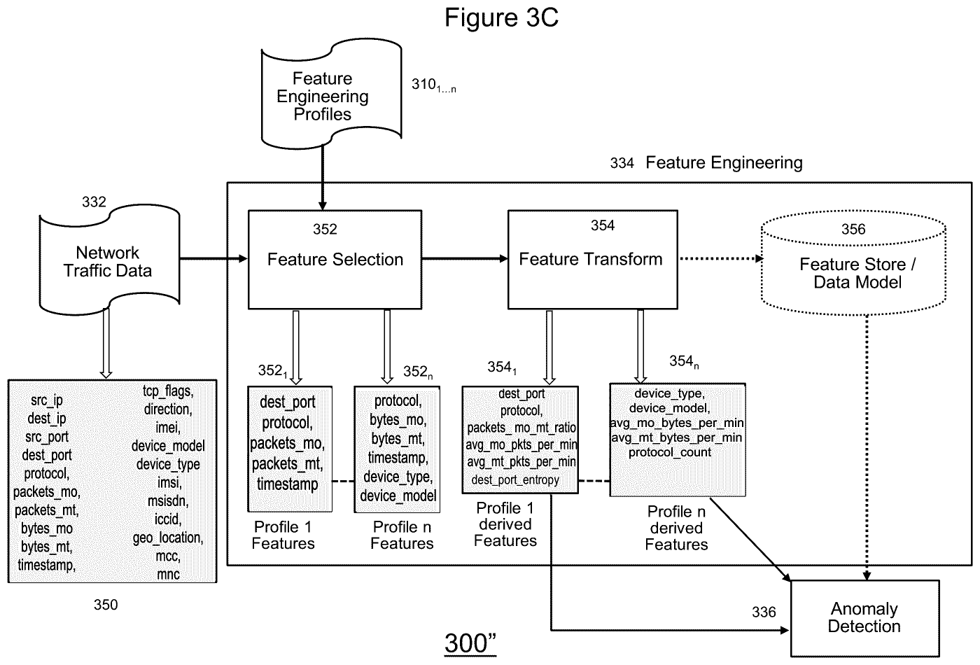

Additionally or alternatively, in an embodiment, as illustrated in FIGS. 1C, 3A, 3B and 3C, the method and system for detecting network intrusions and/or user misuse in a SaaS platform may further include applying feature engineering technique/process to each of the derived groups including any of: extracting features, selecting features, transforming features, and combining features, or a combination thereof, based on the group. Network intrusions and/or user misuse in a SaaS platform may thus be detected using hierarchical grouping of devices and applying feature engineering technique/process by detecting device level network traffic anomaly with any of the said groups in a IoT SaaS connectivity platform.

The anomaly detection using derived and/or pre-determined device groups 220 illustrated in FIG. 2 and described in the description accompanying FIG. 2, and application of feature engineering techniques is illustrated in FIGS. 3A, 3B and 3C and described in detail in the description accompanying FIGS. 3A, 3B and 3C.

FIG. 3A illustrates an exemplary system and process 300 used for applying feature engineering techniques/processes to each of the derived groups including any of: extracting features, selecting features, transforming features, and combining features, or a combination thereof, based on the group for detecting network intrusions and/or user misuse in a SaaS platform.

For example, once the groups are formed or derived based on the hierarchical device grouping as illustrated in FIG. 2, feature engineering techniques/processes may be applied per group as illustrated in FIGS. 3A, 3B and 3C. For both training and detection, features are extracted and/or selected and/or transformed and/or combined based on groups. Applying feature engineering techniques/processes may include, for example, dynamic feature selection per group.

The dynamic feature selection for a profile may be based on the type of anomaly the system wants to detect, for example, to detect anomalies in specific service or application usage, the “packet-count by port” feature can be built from the actual port list for each group. A person skilled in the art may readily recognize that this type of anomaly detection is provided as an example only, and different types of anomaly detection would warrant different selection of features.

As illustrated in FIG. 3A, the system 300 for applying feature engineering techniques/processes may include a memory, one or more databases and at least one processor to perform steps such as profiling 302, training 320 and/or detection 330. The system or module for applying feature engineering techniques/processes 300 may be provided as a part of IoT server platform 204 as illustrated in FIG. 2 or as a separate module and the module for applying feature engineering techniques/processes 300.

Profiling module 302 may include a profile building module 308 that receives derived device groups 304 and network traffic historical data 306 and builds profiles per-level 310_{1 . . . n}. When applying dynamic feature selection per group, an entropy of each feature is measured for each group, and features having high entropy are removed as irrelevant. As a result, each group and/or level will have a different set of feature sets for training and/or detection. For each group, different feature sets can be built from historical data in a dynamic fashion. For example, the “packet-count by port” feature can be built from the actual port list for each group, rather than a pre-defined static list of ports. When applying feature transform per group, for each group, statistical metrics (e.g., min, max, mean, standard deviation, etc.) are measured from historical data and stored in group profiles. These different sets of parameters for each group are then used to normalize/standardize the train/test data as illustrated by training phase performed by a training module 320.

In an embodiment, appropriate feature engineering profile(s) 324 from the per-level feature engineering profiles 310_{1 . . . n} may then be applied to a training dataset including network traffic data 322 for data modeling/training 326 to create per-level data models 328_{1 . . . n}, which may then be used for anomaly detection 336 during the detection phase performed by a detection module 330.

FIG. 3B illustrates a system 300′ for applying feature engineering technique/process, wherein the processor is configured to perform the feature engineering technique 324 as applied during the training phase by the training module 320. For example, application of feature engineering process 324 during training phase 320 includes receiving network traffic data 322, which is also referred to as a training dataset during the training phase 320 and feature engineering profiles per level 310_{1 . . . n} in a hierarchical grouping, applying feature selection and feature transformation. For example, the network traffic training dataset 322 may include parameters or attributes including any one or more of: source IP address (src_ip), destination IP address (dest_ip), source port (src_port), destination port (dest_port), protocol, mobile originated packets (packets_mo), mobile terminated packets (packets_mt), mobile originated bytes (bytes_mo), mobile terminated bytes (bytes_mt), timestamp, transmission control protocol flags (tcp_flags), direction, international mobile equipment identity (imei), device model (device model), device type (device_type), international mobile subscriber identity (imsi), mobile station international subscriber directory number (msisdn), integrated circuit card identifier (iccid), geolocation (geo_location), mobile country code (mcc), mobile network code (mnc) etc.

Although certain attributes also known as features or parameters of raw data are listed here, a person skilled in the art may readily understand that other attributes/features/parameters may also be used and are within the spirit and scope of the present invention.

The feature selection step 342 may select features or attributes also referred to herein as parameters, for each profile based on the type of anomaly the system wants to detect, including parameters or attributes including any one or more of: src_ip, dest_ip, src_port, dest_port, protocol, packets_mo, packets_mt, bytes_mo, bytes_mt, timestamp, tcp_flags, direction, imei, device_model, device_type, imsi, msisdn, iccid, geo_location, mcc, mnc etc., for example, dest_port, protocol, packets_mo, packets_mt, and timestamp for profile 1 342₁ and protocol, bytes_mo, bytes_mt, timestamp, device_type, and device_model for profile n 342ₙ.

The feature transformation step 344 may transform the selected features or attributes, also referred to herein as parameters, for each profile based on the type of anomaly the system wants to detect, to derived features for that profile including but not limited to ratio of mobile originated (MO) packets (traffic) to mobile terminated (MT) packets (traffic) (packets_mo_mt_ratio), average of MO packets per minute (avg_mo_packet_per_minute), destination port entropy (dest_port entropy), average of MO bytes per minute (avg_mo_bytes_per_min), average of MT bytes per minute (avg_mt_bytes_per_min) and protocol count per profile (protocol_count for profile), etc., for example, dest_port, protocol, packets_mo_mt_ratio, avg_mo_packet_per_minute, and destination port entropy (dest_port_entropy), for profile 1 344₁ and device type, device_model, avg_mo_bytes_per_min, avg_mt_bytes_per_min and protocol_count for profile n 344ₙ.

A person skilled in the art may readily understand that although some parameters/features are listed here for feature selection and some derived parameters/features are listed here for feature transformation, they are provided as examples only, and many different and/or additional parameters/features and derived parameters/features may be used based on the type of anomaly the system wants to detect, and that will be within the spirit and scope of this invention.

These derived/transformed features 344₁ . . . 344ₙ may be stored in a feature store 346 for data modeling/training 326 to create per-level data models 328_{1 . . . n}, during the training phase 320. The per-level data models 328_{1 . . . n} may then be used for anomaly detection 336 during the detection phase 330. The feature store may just store derived features for further use, for example, or data modeling/training step 326, or may also perform data modeling to be used for data training step 326 to create per-level data models 328_{1 . . . n}, which may then be used for anomaly detection 336 during the detection phase 330. The data modeling may thus be performed either at the feature store 346, at 326 or both. The data modeling/training step 326 may therefore involve only data training, or both data modelling and training.

Appropriate feature engineering profile(s) 334 from the per-level feature engineering techniques using per level feature engineering profiles 310_{1 . . . n} may then be applied to network traffic data 332 during detection phase 330 and used by anomaly detection 336 along with an appropriate per-level data models 328_{1 . . . n} for that level to provide anomaly detection results per-level or per group as 338_{1 . . . n}.

FIG. 3C illustrates a system 300″ for applying feature engineering technique/process, wherein the processor is configured to perform feature engineering technique 334 as applied during the detection phase by the detection module 330. For example, application of feature engineering process 324 during detection phase 330 includes receiving network traffic data 332, and feature engineering profiles per level 310_{1 . . . n} in a hierarchical grouping, applying feature selection and feature transformation. For example, the network traffic data 332 may include parameters or attributes including any one or more of: src_ip, dest_ip, src_port, dest_port, protocol, packets_mo, packets_mt, bytes_mo, bytes_mt, timestamp, tcp_flags, direction, imei, device_model, device_type, imsi, msisdn, iccid, geo_location, mcc, mnc etc.

Although certain attributes also known as features or parameters of raw data are listed here, a person skilled in the art may readily understand that other attributes/features/parameters may also be used and are within the spirit and scope of the present invention.

The feature selection step 352 may select features or attributes, also referred to herein as parameters, for each profile based on the type of anomaly the system wants to detect including any one or more of: src_ip, dest_ip, src_port, dest_port, protocol, packets_mo, packets_mt, bytes_mo, bytes_mt, timestamp, tcp_flags, direction, imei, device_model, device_type, imsi, msisdn, iccid, geo_location, mcc, mnc etc., for example, dest_port, protocol, packets_mo, packets_mt, and timestamp for profile 1 352₁ and protocol, bytes_mo, bytes_mt, timestamp, device_type, and device_model for profile n 352ₙ.

The feature transformation step 354 may transform the selected features or attributes for each profile based on the type of anomaly the system wants to detect to derived features for that profile including but not limited to ratio of mobile originated (MO) packets (traffic) to mobile terminated (MT) packets (traffic) (packets_mo_mt_ratio), average of MO packets per minute (avg_mo_packet_per_minute), destination port entropy (dest_port_entropy), average of MO bytes per minute (avg_mo_bytes_per_min), average of MT bytes per minute (avg_mt_bytes_per_min) and protocol count per profile (protocol_count for profile), etc., for example, dest_port, protocol, packets_mo_mt_ratio, avg_mo_packet_per_minute, and dest_port_entropy, for profile 1 354₁ and device_type, device_model, avg_mo_bytes_per_min, avg_mt_bytes_per_min and protocol_count for profile n 354ₙ.

A person skilled in the art may readily understand that although some parameters/features are listed here for feature selection and some derived parameters/features are listed here for feature transformation, they are provided as examples only, and many different and/or additional parameters/features and derived parameters/features may be used based on the type of anomaly the system wants to detect, and that will be within the spirit and scope of this invention.

These derived/transformed features 354₁ . . . 354ₙ may be optionally stored in a feature store 356 and used for anomaly detection step 336 or directly used for anomaly detection step 336.

Appropriate feature engineering profile(s) 354₁ . . . 354ₙ from 334 from the per-level feature engineering techniques using per level feature engineering profiles 310_{1 . . . n} may then be applied to network traffic data 332 during detection phase 330 and used by anomaly detection 336 along with an appropriate per-level data models 328_{1 . . . n} for that level to provide anomaly detection results per-level or per group as 338_{1 . . . n}.

Automatic learning of network traffic flow metadata fingerprint for a group of devices may be used to identify anomalies, for example by using ML based anomaly threshold finder and thereby detecting device level network traffic anomaly with any of the said groups in a IoT SaaS connectivity platform.

A person skilled in the art may understand that although a number of examples for creating groups and applying context-based feature engineering technique/process are provided herein, various other parameters, also referred to herein as features, or attributes may be used for creation of groups and applying context-based feature engineering technique/process based on various parameters or attributes.

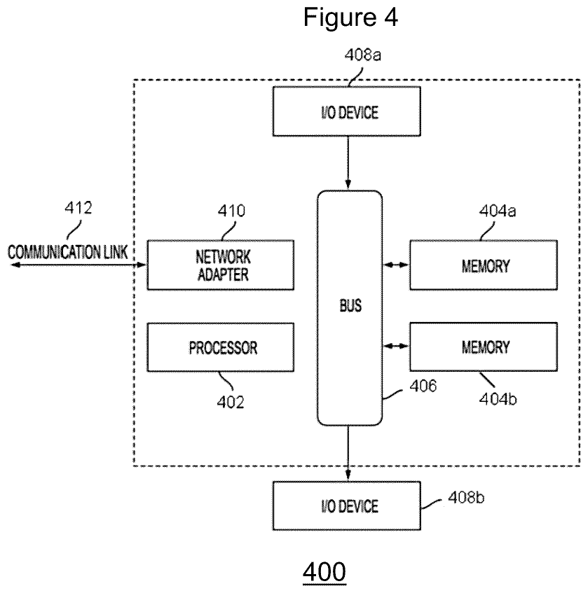

FIG. 4 illustrates a data processing system 400 suitable for storing the computer program product and/or executing program code in accordance with one or more embodiments of the present invention. The data processing system 400 includes a processor 402 coupled to memory elements 404a-b through a system bus 406. In an embodiment, the data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to the data processing system 400. I/O devices 408a-b may be coupled to the data processing system 400 directly or indirectly through intervening 1/O controllers (not shown).

In FIG. 4, a network adapter 410 is coupled to the data processing system 402 to enable data processing system 402 to become coupled to other data processing systems or remote printers or storage devices through communication link 412. Communication link 412 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include digital versatile disk (DVD), compact disk-read-only memory (CD-ROM), and compact disk—read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, terminal, remote device, wireless asset, etc. are intended to be inclusive, interchangeable, and/or synonymous with one another and other similar communication-based equipment for purposes of the present invention though one will recognize that functionally each may have unique characteristics, functions and/or operations which may be specific to its individual capabilities and/or deployment.

Similarly, it is envisioned by the present invention that the term communications network includes communications across a network (such as that of a M2M but not limited thereto) using one or more communication architectures, methods, and networks, including but not limited to: Code Division Multiple Access (CDMA), Global System for Mobile Communications (GSM) (“GSM” is a trademark of the GSM Association), Universal Mobile Telecommunications System (UMTS), Long Term Evolution (LTE), fourth generation cellular systems (4G) LTE, 5G, wireless local area network (WLAN), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for hierarchical grouping of devices in a Software as a Service (SaaS) platform for one or more devices comprises:
receiving device information for the one or more devices;
receiving metadata related to network traffic flow for the one or more devices;
grouping the devices based on any one or more of: received device data, received network traffic flow metadata, or a combination thereof;
dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

2. The method of claim 1, further comprising: detecting device level network traffic anomaly with any of the said groups in a IoT SaaS connectivity platform.

3. The method of claim 1, wherein the metadata related to the network traffic flow includes any one or more of: source IP, source port, destination IP, destination port, protocol, data bytes and packet count.

4. The method of claim 1, wherein grouping the one or more devices within an account comprises static grouping based on tenant identifier.

5. The method of claim 2, further comprising learning of device group fingerprint to identify anomalies.

6. The method of claim 1, further comprising applying feature engineering technique to each of the groups including any of: extracting features, selecting features, transforming features, and combining features, or a combination thereof, based on the group.

7. The method of claim 6, further comprising: detecting device level network traffic anomaly with any of the said groups in a IoT SaaS connectivity platform.

8. A system for hierarchical grouping of devices in a Software as a Service (SaaS) platform comprising an IoT server platform including a processor and memory, wherein the IoT server platform is configured to:
receiving device information for the one or more devices;
receiving metadata related to network traffic flow for the one or more devices;
grouping the devices based on any one or more of: received device data, received network traffic flow metadata, or a combination thereof;
dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

9. The system of claim 8, wherein the IoT server platform is further configured to: detect device level network traffic anomaly with any of the said groups in a IoT SaaS connectivity platform.

10. The system of claim 8, wherein the metadata related to the network traffic flow includes any one or more of: source IP, source port, destination IP, destination port, protocol, data bytes and packet count.

11. The system of claim 8, wherein grouping the one or more devices within an account further comprises static grouping based on tenant identifier.

12. The system of claim 9, further comprising learning of device group fingerprint to identify anomalies.

13. The system of claim 8, further comprising applying feature engineering technique to each group including any of: extracting features, selecting features, transforming features, and combining features, or a combination thereof, based on the group.

14. The system of claim 13, further comprising: detecting device level network traffic anomaly with any of the said groups in a IoT SaaS connectivity platform.

15. A computer program product stored on a non-transitory computer readable medium for hierarchical grouping of devices in a Software as a Service (SaaS) platform, comprising computer readable instructions for causing a computer to control an execution of an application for hierarchical grouping of devices comprising:
receiving device information for the one or more devices;
receiving metadata related to network traffic flow for the one or more devices;
grouping the devices based on any one or more of: received device data, received network traffic flow metadata, or a combination thereof;
dynamically grouping the one or more devices within the said group based on learning communication behavior of the devices within the said group using machine learning algorithm, wherein parameters for the communication behavior include any one or more of: destination IP, destination port, protocol, data usage, time of the day, day of the week, device model, ratio of mobile originated (MO) traffic to mobile terminated (MT) traffic, and parameters derived from any one or more of the said parameters.

16. The computer program product of claim 15, further comprising instruction for detecting device level network traffic anomaly with any of the said groups in a IoT SaaS connectivity platform.

17. The computer program product of claim 15, wherein the metadata related to the network traffic flow includes any one or more of: source IP, source port, destination IP, destination port, protocol, data bytes and packet count.

18. The computer program product of claim 15, wherein grouping the one or more devices within an account further comprises static grouping based on tenant identifier.

19. The computer program product of claim 16, further comprising instruction for learning of device group fingerprint to identify anomalies.

20. The computer program product of claim 15, further comprising applying feature engineering technique to each group including any of: extracting features, selecting features, transforming features, and combining features, or a combination thereof, based on the group.

21. The computer program product of claim 20, further comprising instruction for detecting device level network traffic anomaly with any of the said groups in a IoT SaaS connectivity platform.
